(19) United States
(12) Patent Application Publication
(10) Pub. No.: US 2014/0263622 A1
(43) Pub. Date: Sep. 18, 2014

(54) METHODS AND SYSTEMS FOR AUTHENTICATING A TRANSACTION WITH THE USE OF A PORTABLE ELECTRONIC DEVICE

(71) Applicant: BLITZPAY, INC., Redwood City, CA (US)

(72) Inventors: Adolfo BABATZ, San Mateo, CA (US); Vilash Poovala, Redwood City, CA (US)

(21) Appl. No.: 13/827,299

(22) Filed: Mar. 14, 2013

(51) Int. Cl. G06Q 20/34; G06Q 20/36

(52) U.S. Cl. CPC G06Q 20/34; G06Q 20/36
USPC 235/380

(57) ABSTRACT

Methods and systems for secure transaction authentication. The card is read in a POS reader, data is sent to a remote server after being encrypted, a code is then sent from the remote server to a unique identifier provided as a proof of authentication, thereafter the code is provided to authenticate the transaction. The methods and systems may include obtaining a unique identifier from the user, such as a mobile telephone number. In some configurations, the data of the mobile telephone number can be compared to patterns of activity related to usage of the mobile telephone number. The methods and systems may include sending a code that is provided by during the transaction and verifying that the code provided matches with the code sent by the remote server.

### FIELD OF THE INVENTION

The present invention is directed to a method and system which uses a first or primary electronic device, a point of sale terminal (POS) or POS system and a second or secondary electronic device to authenticate a user of a card, such as a credit card, prepaid closed loop and open loops card, reloadable cards, loyalty cards, and non-monetary currency based cards. Specifically, the present invention refers to a method and to a system which provide a second authenticating mechanism for authenticating a card user.

### BACKGROUND

The authentication process currently dictated by the credit and debit card associations as well as by banks, where verification is carried out through secondary identification of a user of the card by, for example, a photograph or signature identification has low reliability. Among other reasons contributing to the low reliability, is that it is common when a card is stolen, that the cardholder takes more than 24 hours to report the loss

The use of short message service texts (SMS) for transmission of data between, for example, a mobile communication device and a remote server has been described in, for example, U.S. Pat. No. 8,029,365 B2 issued Oct. 4, 2011, entitled Hierarchical Multi-Tiered System for Gaming Related Communications by Burke et al. SMS has a variety of uses, including the automated activation of a mobile payment bill on a portable electronic device, wherein a user associated with a mobile payment bill is authenticated, such as is described in the publication of US Publication No. US 2012/0078735 A1 published Mar. 29, 2012, entitled Secure Account Provisioning to Bauer, et al.

In US Publication No. US 2006/0206709 A1 published Sep. 14, 2006, entitled Authentication Services Using Mobile Device by Labrou, et al. (now U.S. Pat. No. 7,606,560 B2 issued Oct. 4, 2011), a second authenticating factor for providing secure transactions is described. In Labrou, the focus of the disclosure is on the authorized user of the transaction on the user's mobile device.

What is needed are systems and methods for providing an authentication process on different devices, such as a first or primary mobile device or a POS terminal, where the first mobile device or POS terminal belongs to a merchant, and a second pr secondary mobile device which belongs to the credit cardholder, to increase the card use reliability, given that the probability of both, the card and the mobile device of the cardholder being stolen is low.

### SUMMARY OF THE INVENTION

An aspect of the disclosure is directed to the merchant's application and consequently initially designed for the merchant's protection against fraud by the consumer, and in a secondary manner the cardholder.

Another aspect of the disclosure is directed to methods and systems to reduce fraud in the point of sale (POS) transactions, lowering as a consequence, the fraud rate.

Still another aspect of the disclosure is directed to the creation of digital wallets by means of the system in the present invention.

Another aspect of the disclosure is directed to the method and the system which includes authentication methods carried out in a single application performed on a mobile device.

An additional aspect of the disclosure is directed to methods and systems for providing a sense of security to both the merchant who uses the method and system of the present invention, as well as to the cardholder.

A method and a system for the authentication of data between a first device/system at a point of sale (POS) is described. The method and system utilize a remote server and a mobile device of a cardholder. The method can also include carrying out on the POS device an application capable of reading a card provided by the card's user, obtaining in at least a first time a mobile telephone number of the card user, sending encrypted data to the remote server, including the data of the user's mobile telephone or that of the cardholder, sending a code to the cardholder's mobile telephone, and introducing the code into the POS device. In embodiments, the card user may sign on the POS device to finalize the authentication. In some configurations, the need of having the physical presence of the card is eliminated. In other configurations, after carrying the application out on the POS device/system, the cardholder's telephone number may be requested and the telephone number may be sent as part of the encrypted data to the remote server. In still other configurations, the request for a credit is included or rather, the sending of a bill or receipt via different means. Discounts or coupons or loyalty points can also be sent to the cardholder.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE FIGURES

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a general flow diagram, without the card user's Out of Band authentication process of the present invention;

FIG. 2 is a flow scheme of the parts of the method and system for authentication of the present invention;

FIG. 3 is a flow diagram particular to the authentication method of the present invention, with the out of band authentication process of the client. The flow diagram is in correlation with the flow diagram of FIG. 1; and

FIG. 4 is a further flow diagram particular to the authentication process of the present invention.

### DETAILED DESCRIPTION OF THE INVENTION

The methods and systems described herein are configurable to operate, for example, on a logic device through which a browser can be accessed. A computer system (or digital device), which may be understood as a logic apparatus adapted and configured to read instructions from media and/or network port, is connectable to a server, and may have a fixed media. The computer system can also be connected to the Internet or an intranet. The system includes central processing unit (CPU), disk drives, optional input devices, such as a keyboard and/or mouse and optional monitor. Data communication can be achieved through, for example, communication medium to a server at a local or a remote location. The communication medium can include any suitable means of transmitting and/or receiving data. For example, the communication medium can be a network connection, a wireless connection or an internet connection. It is envisioned that data relating to the present invention can be transmitted over such networks or connections. The computer system can be adapted to communicate with a participant and/or a device used by a participant. The computer system is adaptable to communicate with other computers over the Internet, or with computers via a server.

The computing system is capable of executing a variety of computing applications, including computing applications, a computing applet, a computing program, or other instructions for operating on computing system to perform at least one function, operation, and/or procedure. Computing system is controllable by computer readable storage media for tangibly storing computer readable instructions, which may be in the form of software. The computer readable storage media adapted to tangibly store computer readable instructions can contain instructions for computing system for storing and accessing the computer readable storage media to read the instructions stored thereon themselves. Such software may be executed within CPU to cause the computing system to perform desired functions. In many known computer servers, workstations and personal computers CPU is implemented by micro-electronic chips CPUs called microprocessors. Optionally, a co-processor, distinct from the main CPU, can be provided that performs additional functions or assists the CPU. The CPU may be connected to co-processor through an interconnect. One common type of coprocessor is the floating-point coprocessor, also called a numeric or math coprocessor, which is designed to perform numeric calculations faster and better than the general-purpose CPU.

As will be appreciated by those skilled in the art, a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Some embodiments may be implemented in one or a combination of hardware, firmware and software. Embodiments may also be implemented as instructions stored on a non-transitory computer-readable storage medium, which may be read and executed by at least one processor to perform the operations described herein. A non-transitory computer-readable storage medium may include any mechanism for storing information in a form readable by a machine (e.g., a computer). For example, a non-transitory computer-readable storage medium may include read-only memory (ROM), random-access memory (RAM), magnetic disk storage media, optical storage media, flash-memory devices, and other non-transitory media.

In operation, the CPU fetches, decodes, and executes instructions, and transfers information to and from other resources via the computer's main data-transfer path, system bus. Such a system bus connects the components in the computing system and defines the medium for data exchange. Memory devices coupled to the system bus include random access memory (RAM) and read only memory (ROM). Such memories include circuitry that allows information to be stored and retrieved. The ROMs generally contain stored data that cannot be modified. Data stored in the RAM can be read or changed by CPU or other hardware devices. Access to the RAM and/or ROM may be controlled by memory controller. The memory controller may provide an address translation function that translates virtual addresses into physical addresses as instructions are executed.

In addition, the computing system can contain peripherals controller responsible for communicating instructions from the CPU to peripherals, such as, printer, keyboard, mouse, and data storage drive. Display, which is controlled by a display controller, is used to display visual output generated by the computing system. Such visual output may include text, graphics, animated graphics, and video. The display controller includes electronic components required to generate a video signal that is sent to display. Further, the computing system can contain network adaptor which may be used to connect the computing system to an external communications network.

Code includes, for example, the security elements which are unique, possibly different and random. In some cases, the code may consist of at least one digit, preferably between 3 and 10 digits, wherein the digits may be numerical, alphanumerical or alphabetical, such as is known in the art. Code may also consist of between 4 and 6 digits.

Card includes, for example, a payment delivery device. By the way of example, without being limited necessarily to the following, a card can be a debit card, a credit card or similar, such as open-loop and closed-loop pre-paid or reloadable cards or those linked to mobile accounts.

Cardholder is a person to whom the card was issued by a card issuing entity and who legally possesses the card or possesses the card with the permission of the cardholder to whom the card was issued. The cardcholder is an authorized user.

The description makes reference to a system and method for the authentication of the user of a card to allow the carrying out of a transaction. The method and system provides a level of assurance to the parties to the transaction, either or both of the cardholder and the merchant, via an available network for card processing, that the card user is an authorized user. This process can be achieved by carrying out the authentication process by using, for example, a unique message, encrypted point-to-point via a secure channel, authorizing each transaction with a particular code.

It is known that the card carrier or card user may not always be the authorized cardholder. It is also possible that the card user or card carrier is different than the cardholder, whether it is because the cardholder lent the card to the card user or because the user is committing fraud (e.g., the card has been stolen or cloned). Therefore, for the present application, the term “card user” is different than the tem “cardholder”, where the cardholder is an individual to whom the card issuer issued the card, while the card user is the person who is actually using the card at any particular point in time. The card user may be the cardholder (or an authorized user) or the card user may be a fraudulent user.

It is common that when a card has been stolen from a cardholder, the card is often used immediately or imminently by the card user, typically within 24 hours from the theft, which also corresponds to the average time it takes a cardholder to communicate the card loss to the card issuer (or bank). A security system for the cardholder and merchant which facilitates establishing whether the card user is the cardholder is desirable.

The disclosed system and method changes the card acceptance process at the point of sale (POS) which is currently accomplished by verifying the identity of the card user as the cardholder by a secondary process, such as reviewing a photograph.

Similarly, a change in the manner in which electronic devices (such as mobile telephones) are used is provided, given that these electronic devices can be used as transaction acceptance terminals of cards, as well as an authenticator for the transaction. When relying on the telephone, as well as the application, to undertake a verification process with the Out-of-Band (OBA) authentication processes, the mobile telephones, especially the smart mobile telephones, are converted into verification or transaction authentication tools.

FIG. 1 illustrates the implementation of a communication method 10 generally employed in the art. The communication system in the POS which is deployed on a mobile telephone, preferably a merchant's smart mobile telephone, on which an application has been installed. It is possible that the POS is directly connected to the merchant's mobile telephone. It is preferable that the merchant's mobile telephone have an iOS or Android operative system, however, the application can be carried out on any operative system for mobile telephones. The application consists of an input by the merchant 12 in which the merchant is required to have a user account, which can be for example, an email account or a mobile telephone number, as well as a password. Upon having created an account and the merchant having downloaded the application with his credentials, the amount to be charged is input 14 as well as the card data, by any suitable mechanism or process known in the art, whether it be by sliding the user's card through a magnetic reader band, or rather by use of a reader chip, or by directly inputting the card numbers into the application or into the POS device, or yet by payment without contact, including in, for example, the card, or rather, the application searches for the user's previously registered card, or yet, if the communication technology in near field better known as “near field communication” (NFC) technology is available, the merchant's mobile device may request authorization from a user's mobile device to begin the transaction and continue with the process. Having read the card, the information of the read card may be displayed, as well as the name of the cardholder and other fields to confirm the transaction. When undertaking the last step, an interstitial page is displayed on which the confirmation 16,18 with the card's issuer is carried out, as well as possibly with the bank related to the cardholder, so that both of these entities may authorize the transaction in a conventional manner through the inter-bank network. If both the card issuer, (e.g., the bank that issued the card or the bank that is related to the cardholder) approves the transaction 18, the card user inputs his signature 20 into the mobile device, so that afterwards the merchant may approve the signature and may press to continue 22. Once the transaction has been processed and approved, a new page 26a/26b appears in which the cardholder asks for his receipt, such as can be short message service (SMS) or an email. The receipt can be an invoice, a simple receipt or a purchase notification. The process is usually finalized 28 by acceptance of the payment and by sending a notification 26. The above described process is currently being carried out at stores, however, the manner through which the card user is verified as being one and the same as the cardholder, continues to be the traditional manner dictated by the banks and card issuer, wherein a visual recognition of the cardholder, or yet, a confirmation which often is not carried out by the merchant's employees, which lends itself to fraud. Similarly, in the above described process, the mobile telephone of the cardholder has no relevance or very little relevance in the authorization process.

Therefore, as was previously mentioned, a more reliable assurance is provided to both the cardholder as well as to the merchant, possibly omitting the need to undertake a visual confirmation in the manner currently conventionally used by both the banks and/or the card issuer.

FIG. 2 describes a communication system and partly, a method of authentication. As illustrated, the communication system has three main components, a merchant's device 150, a server 200 and a cardholder's device 220. The server 200, may be part of the card issuer's server, or part of the cardholder's bank servers or even a third party's servers which only relate the card numbers with the mobile telephone numbers of the cardholder. The card fields and the mobile telephone fields can be in different data bases. Similarly, information pertinent to the card and information pertinent to the cardholder's mobile device can be located on two separate servers, which can be remote to the transaction and belong to two different parts of the system, for example a server which belongs to the card issuer and another server belonging to a bank or to a third party. It is preferable that the field with the card number can be linked or joined to the field with the mobile telephone of the cardholder, thus creating client portfolios wherein the cards are linked to the mobile telephone numbers.

On the merchant's side 150, the merchant can have a suitable POS device 152 onto which an application is loaded. Such POS device 152 can be, or can be in connection with, by way of example, a mobile telephone; however, it is possible that instead of a mobile telephone, it can consist of a system with a website with the ability to carry out electronic business, where the system has the capability of sending and receiving a communication via an interbank network, as well as having the capability of sending and receiving a communication using known network protocols such as a file transfer protocol (FTP) or a simple mail transfer protocol (SMTP), as well as having the capability of sending a communication by different other mechanism, such as wireless application protocols (WAP).

The protocols described herein are examples of the protocols which can be used to implement the disclosure; however, the disclosure is not limited to making use solely of the protocols described.

The POS device 152 is capable of inputting the card data 154 by any currently known process, such as for example, by sliding the user's card through a magnetic reader band, or by use of a payment without contact, or by use of near field communication (NFC) technology. The merchant's electronic device may request authorization from a user's electronic device to begin the transaction and continue with the process. It is also possible, that if the card user does not have the physical card present, the user card's data information can be sought, with the end purpose of carrying out the transaction without the physical card being present. For the sake of language simplicity, in the present application, the term “reader 154” can refer to a device capable of inputting the card's data into the system, and the term “reader” can include a data base which contains the information data of the card to be used. The reader 154 usually is capable of encrypting the data on the card which essentially corresponds to a first encryption.

During a first transaction with the card, a merchant 150 can ask the cardholder 220 for an identifier for his or her electronic device 228, such as the telephone number assigned to a mobile phone. The merchant then inputs the identifier 228 into the system. Alternatively, the cardholder's 220 electronic device 228 can be requested at each transaction, with the end purpose of providing yet another authentication mechanism. Upon introducing the electronic device 228 into the system, the system is capable of encrypting this information, same which corresponds to a second encryption.

A network 156, such as can be a MAN or a WAN or through SMS, by way of example, the internet, the merchant's system 150 sends a server 202 the encrypted data, essentially, sends the card data, the transaction data (such as the costs, the time of transaction, the approval request, the geo-location, among others) and the telephone number information data. The encrypted data are received by the server 202, and in its case, a request for the respective transaction approval is sent to the issuer of the card, such as the cardholder's bank, or rather, only to the cardholder's bank, so that it in turn, may send them to the card's issuer or vice versa. In response to the request for the approval of the transaction, the cardholder's bank or the cardholder's card issuer, either approves or denies the request.

In the event that the transaction is approved by the issuer or the bank, either prior to or in conjunction with the approval, a proprietor risk method can be performed to approve or deny the additional transaction to the approval and to the method carried out by the card issuer/bank, can be coordinated by the server 202.

Upon receiving the message encrypted by the merchant's 150 device 152, the server 202 decrypts at least one portion of the message, corresponding to the second encrypted data, essentially the card holder's telephone number data. Upon decrypting the card holder's telephone number data, the system can verify if the card holder's 220 electronic device 228 identification data had been previously registered, linking them through a unique identification number or key or by use of the number of the card being used, or whether it is the first time that the data of the electronic device 228 identifier is registered as well as the card being used. In the event that the data has already been registered, the previously registered data is compared to the decrypted data; in the situation where they match, the electronic device 228 is authenticated and the next step ensues. In the event that they do not match, the system can send an error message to the merchant; alternatively it can over-ride the error and send an alarm to the server of the issuer or the bank or yet, may simply proceed to the next step. In the event that the data is not registered, the electronic device 228 identifier data can then be registered and stored in the system, storing along with the data possibly a unique identification number or key, wherein the unique identification number can, in case the servers are different, share with the server of the issuer of the card or the server of the bank in its corresponding case, or yet correlating the electronic device 228 identifier with the cardholder's card number. Once the electronic device 228 identifier is stored and linked, the next step ensues.

Upon proceeding to the next step, the server 202 sends through a network 224, same which can be the same or different than the network 156, a code 222 to the registered cardholder's electronic device 228 identifier, that is, to the stored and linked electronic device 228 identifier, as opposed to the one provided by the card user. It is preferable that the code 222 be sent to the card holder's 220 electronic device 228 identifier by a short message service (SMS), or yet, the code 222 may be sent to the electronic device through other known processes known in the art of instant messages, such as can be email, or messages through the Extensible Messaging and Presence Protocol (XMPP).

Upon receiving the code in the electronic device 228, the cardholder provides the merchant or directly introduces the code 222 into the system, such as can be directly into the merchant's POS device 152. Alternatively, an information transference system can be used without the cardholder having direct contact with the system or the POS device 152, and without the merchant 150 having to have any direct contact with the code 222. Upon inputting the code 222 into the system or into the POS device 152, a verification which contains the code 222 is sent from the POS device 152, via the network 156, to the server 202, with the end goal of verifying if the code provided by the card user to the merchant or the code input by the card user into the system or into the POS device 152, coincides with the code 222 sent from the server 202 to the cardholder's electronic device 228. The server 202 validates that the code received matches the code sent using, possibly a code identifier search engine. If the code 222 inputted by the user of the code does not coincide with the code 222 sent by the server 202, three options arise. In the first option, the transaction is denied and the denial of the transaction is communicated to the issuer of the card/bank with the end goal of the issuer/bank may in turn issue the transaction credit to its origin. In a second option, the merchant can over-ride and continue with the process as if the codes 222 coincided. In a third option, the code 222 can be requested once again of the card user or the card user can be asked to once again input the code 222. Alternatively, instead of the server 202 sending the transaction approval or denial, it can be opted that the application on the merchant's side verify the state of the code 222 data verification surveying the server 202, so that the following approval or denial of the transaction page may be displayed. In the case of the codes 222 coinciding, it can proceed directly to the requirement of second data for authentication, such as could be the card user's signature and/or the card's personal identification number (PIN), same which can function as a second authentication factor. The second authentication factor is sent via the network 156, same which can be the inter-banking network, whether it is to the server 202, or if the server 202 is different from the server of the bank/issuer, to the server 202 of the issuer or to the server 202 of the bank. The second data may be sent in an encrypted manner or in an unencrypted manner. Similarly, the validation of the coincidence between the codes 222 can be encrypted and sent, in an encrypted manner to the server 202. Through the latter, the authentication is finalized and with it, the transaction.

FIG. 3 shows a flow diagram particular to the authentication method of the present invention, showing possible graphic interfaces for the user which are shown to the merchant. Specifically, as the merchant 150 is inputting the charges and the description of the product or service to be sold, and prior to, the moment of, or after the data of the card has been input into the system by any of the mechanism or process known in the art, the consumer 302 is asked for his or her electronic device 228 identifier such as is shown in step 16a. Once all the necessary data are gathered, the data can be displayed prior to it being sent. Similarly, upon having all the data, the system sends the encrypted data to the server 202. Such as was previously mentioned, the system can then be asked that the encrypted numbers of the electronic device 228 be sent via SMS 304 or via other suitable communication process, such as would be GPRS, IVR 306 or XMPP. Upon receiving the encrypted message from the merchant 150, the server 202 decrypts at least a portion of the message, essentially the cardholder's electronic device 228 identifier data and links them to the unique identification number or a key.

As was previously mentioned, the server 202 is capable of sending a code 222 via network 224 to the cardholder's registered electronic device 228. Upon receiving the code 222 on the electronic device 228, the cardholder provides to the merchant, directly introducing into the system such as can be directly into the merchant's POS device 152, or transmits the information in a wireless manner to the system, the code 222 in the pertinent fields 308 to be able to input the code, such as is shown in step 16b. Once the cardholder or the merchant has input 310 the received code 222, the icon is pressed 312 so that the system may continue, carrying out steps 22-28 of the main flow system, where the code 222 inputted by the merchant or the cardholder is then verified and ensured that it matches with the code 222 sent to the cardholder's mobile telephone 228. Specifically, upon inputting the code 222, a verification which contains the code 222 is sent from the POS device 152 via network 156 to the server 202 with the end goal of verifying if the code inputted by the user matches the code 222 sent from the server 202 to the cardholder's electronic device 228. The server 202 can then send back a validation for the transaction, a decline or may require that the code 222 be input once again. Alternatively, the system or POS device 152 is capable of surveying the server to verify the transaction validation or the transaction decline or whether the code 222 is being required to be input once again. Upon authenticating the transaction, the transaction is assigned a higher or a lower risk certification and based on this parameter; the transaction is either accepted or denied.

Once having the user's electronic device 228 identifier and having approved the transaction, the necessary fields can be pre-populated to send the receipt or invoice, for example, the necessary electronic device 228 identifier for the receipt or the invoice may be pre-populated in step 26b.

Having had the necessary details approved one can chose whether the invoice is to be sent by electronic mail processor 50 or rather to have it sent via an SMS 52. If it is sent by email 50, there is a field 502 to input the email address. If it is sent via SMS, there can be a field 504 to input the card user's electronic device or yet, this field 504 can be pre-populated with the data previously furnished by the cardholder and stored in the system or rather, with the data furnished by the server 202.

In so far as this invention has been described in terms of several embodiments, alterations and permutations and the equivalent exist which fall within the reach of this invention. It should also be noted that there are many alternative ways to implement the devices and methods of the present invention. Consequently, it is pretended that the following claims be interpreted including all such alterations, permutations and the like equivalent in so far as they fall within the true spirit and reach of the present invention.

Particularly, it is indicated that, the scheme of the invention, may also be implemented in programming schemes. The implementation may use a digital storage device, particularly a flexible disc or a CD with control signals which can be read electronically, apt to cooperate with a programmable computer system in such a way that the corresponding method is executed. In general, the invention as such also consists of computer program product codes stored in a carrier which may be read by a machine in order to carry out the method of the invention, when the computer program product is executed on a computer.

What is claimed is:

1. A method for secure authentication comprising:
reading the card at a POS reader;
sending to a remote server encrypted data;
sending a code from the remote server to at least one electronic device, some of which might already be registered to the cardholder in the system; and
introducing the code into the POS reader to authenticate a transaction.

2. The method according to claim 1, wherein the method further comprises obtaining at least one unique identifier of the user, and including in the encrypted data the unique identifier.

3. The method according to claim 1, wherein the server decrypts at least the unique identifier for the electronic device provided by the user, stores the unique identifier for the electronic device and links the unique identifier for the electronic device to the card.

4. The method according to claim 1, wherein the code is sent by a one or more of a short message service (SMS), electronic mail, by messages with extensible messaging and presence protocol (XMPP), Apple Push Notification Services (APNS), Google Play Push Notifications, Skype Peer-to-Peer Internet Telephony Protocol.

5. The method according to claim 1, wherein the method additionally comprises:
sending the code input in the POS reader to the server;
verifying that the code input in the POS reader coincide with the code sent by the remote server.

6. The method according to claim 5, wherein if upon verifying the codes, the codes do not coincide, the transaction is declined or a merchant in charge of the POS reader over-rides the decline and continues with the process as if the codes had coincided.

7. A method for secure authentication comprising:
reading the card in a POS reader;
sending a remote server encrypted data of a card and of a unique identifier supplied by a user; and
inputting a code into the POS reader wherein the code was provided to the unique identifier of the user.

8. The method according to claim 7, wherein a merchant in charge of the POS reader over-rides a transaction denied and continues with the process.

9. A method for secure authentication comprising:
receiving on a server encrypted data of a card;
sending a code from a remote server to an electronic device associated with the card;
receiving on a remote server a code provided by a card user; and
comparing the code provided to the code sent to the electronic device.

10. The method according to claim 9, wherein the server decrypts at least the unique identifier for the electronic device of the encrypted data, stores the unique identifier for the electronic device and links the unique identifier for the electronic device to the card.

11. A system for authenticating a user of a card comprising:
a POS reader capable of encrypting and sending data related to the card and of a unique identifier for the electronic device provided by the card user;
accepting and sending an inputted code;
a server capable of receiving the encrypted data, decrypting at least the data of the unique identifier for the electronic device and sending a code related to the transaction, wherein the server is capable of receiving the inputted code and of comparing the inputted code to the code related to the transaction; and
an electronic device of the cardholder associated with the card capable of receiving the code related to the transaction.

12. The system according to claim 11, wherein the server sends the code through a one or more of a short message service (SMS), electronic mail or by messages with extensible messaging and presence protocol (XMPP), Apple Push Notification Services (APNS), Google Play Push Notifications, Skype Peer-to-Peer Internet Telephony Protocol.

13. The system according to claim 11, wherein the POS reader is capable of sending the inputted code and wherein the server is capable of verifying that the inputted code matches with the code sent by the server.

14. A method for creating an electronic wallet comprising:
reading a card at a POS reader;
sending to a remote server encrypted card data;
sending a code from the remote server to a unique identifier supplied by a user;
introducing the code into the POS reader to authenticate a transaction;
creating the electronic wallet for the user associating the card information with the unique identifier.

15. The method for creating an electronic wallet of claim 14 comprising adding card data to a unique identifier of the user.

16. A machine readable medium storing instructions that, when executed on a computing device, cause the computing device to perform a method, the method comprising:
obtaining card information from a POS reader;
sending to a remote server encrypted data obtained from the card;
displaying a prompt for an authentication code; and
receiving the authentication code to authenticate a transaction.
